(19) United States
(12) Patent Application Publication
(10) Pub. No.: US 2012/0130785 A1
(43) Pub. Date: May 24, 2012

(54) METHOD AND SYSTEM FOR REDEEMING REWARDS IN PAYMENT OF A TRANSACTION ACCOUNT

(76) Inventor: Richard Postrel, Miami Beach, FL (US)

(21) Appl. No.: 12/949,351

(22) Filed: Nov. 18, 2010

(51) Int. Cl. G06Q 30/00

(52) U.S. Cl. 705/14.17

(57) ABSTRACT

A transaction aggregator aggregates a plurality of transaction account charges for a user transaction account. The transaction charges are received from merchants for acquisitions made by a user. The user is offered an option to make at least a partial payment to the user transaction account by redeeming rewards from at least one user reward account associated with a rewards issuer. A reward redemption instruction is received from the user, the reward redemption instruction designating the redemption of rewards from at least one user reward account. The user reward account(s) designated by the user is caused to redeem the rewards by decreasing the rewards in the user reward account and conveying corresponding consideration to the transaction aggregator. A credit is provided on the user transaction account for an amount corresponding to the value of the rewards decreased in the user reward account(s).

### TECHNICAL FIELD

This invention relates to reward systems, and in particular to a method and system for redeeming rewards to make payment towards a transaction account.

### BACKGROUND OF THE INVENTION

Users often may earn reward points as part of a transaction with a merchant or issued by a credit card company or a distributor. For example, a merchant and/or issuer may award a user one point for each dollar spent. In this case, a $100 purchase will result in the awarding of 100 reward points, which are tracked in a reward point account stored on a reward point server computer managed by the merchant, issuer or a third party service provider. In addition, credit card issuers may implement their own reward point system, such as AMERICAN EXPRESS MEMBERSHIP REWARDS. In this card issuer-based system, a user may be awarded one point for every dollar spent regardless of the merchant. For example, if a user spends a total of $2,465 in one month with his credit card, the issuer may award him with 2,465 points in a reward account. Often these merchant-based programs are implemented independently from a card issuer-based program, such that a user may be awarded with reward points in multiple accounts based on the same transaction. Airline frequent flyer programs operate similarly and may award points or miles based on the distance or cost of an airplane trip (or on the value of the customer to the airline rather than its distance or cost).

Many programs offer redemption programs in which the user may trade in, or redeem, his reward points in exchange for goods, services, or discounts. For example, a user may redeem 20,000 MEMBERSHIP REWARD points for a music player device, or he may redeem 50,000 AMERICAN AIRLINES points for a free flight or seat upgrade, etc. A major problem in this field is that redemption options are limited to only certain goods available from a certain merchant, issuer, or catalog. Also, users often have small amounts of points in several accounts, each of which provide no meaningful redemption options. It is therefore desired to be able to make use of rewards that have been earned by users from issuers that do not provide any meaningful redemption opportunities.

### SUMMARY OF THE INVENTION

Provided is a computer-implemented method in which a transaction aggregator server computer offers to a user an option to make at least a partial payment to a user transaction account by redeeming rewards from at least one user reward account associated with a rewards issuer. A reward redemption instruction is received from the user, the reward redemption instruction designating the redemption of rewards from at least one user reward account. The transaction aggregator server computer causes the at least one user reward account designated by the user to redeem the rewards by decreasing the rewards in the user reward account and conveying corresponding consideration to the transaction aggregator. A credit is provided on the user transaction account for an amount corresponding to the value of the rewards decreased in the user reward account.

The transaction aggregator server computer may also aggregate a plurality of transaction account charges for the user transaction account, each of said transaction charges received from at least one merchant for an acquisition made by the user with the at least merchant. The acquisition made by the user with the at least one merchant may be a product and/or a service.

The credit may be provided against a total amount owed for the plurality of transaction account charges on the user transaction account, or it may be provided against one of the plurality of transaction account charges for the user transaction account.

The transaction aggregator may be a credit card issuer, in which case the user transaction account is a user credit card account and the transaction account charges are credit card charges made to the user credit card account. The transaction aggregator may be a debit card issuer, in which case the user transaction account is a user debit card account and the transaction account charges are debit card charges made to the user debit card account. The transaction aggregator may be a smart card issuer. The transaction aggregator may also be a bill payment service, in which case the transaction account charges are bills that are paid by the transaction aggregator on behalf of the user.

The option to make at least a partial payment to a user transaction account by redeeming rewards from at least one user reward account associated with a rewards issuer may be provided on a transaction account statement transmitted to the user, which may be a paper statement transmitted to the user via mail and/or an electronic statement made available to the user via a web site.

A list of user reward accounts may be provided to the user that may be designated by the user for the redemption of rewards. Also an indication may be provided to the user of an amount of rewards available from each of the user reward accounts that may be designated by the user for the redemption of rewards. The reward redemption instruction may include an amount of rewards desired by the user to be redeemed. The reward redemption instruction may be an automatic redemption instruction from the user designating an automatic redemption of rewards from a predetermined selection of at least one user reward account. The reward redemption instruction may include an instruction to use a desired percentage of rewards from the at least one user reward account, and/or it may include an instruction to use a predetermined number of rewards from the at least one user reward account.

### BRIEF DESCRIPTION OF THE DRAWING

FIG. 1 is a block diagram of the present invention.

FIGS. 2A and 2B are a flowchart of the operation of the present invention.

### DESCRIPTION OF THE PREFERRED EMBODIMENTS

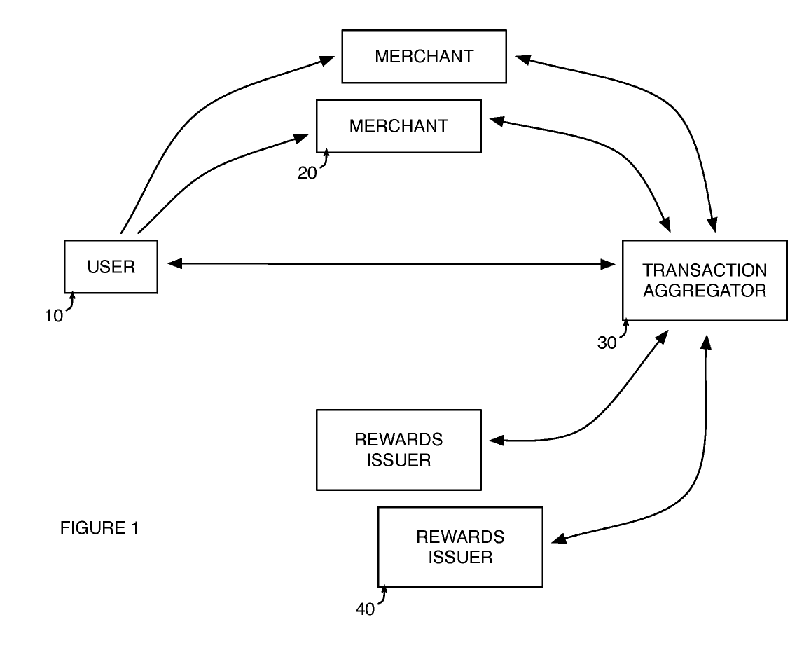

With reference to FIG. 1, the preferred embodiment of the present invention involves a user 10, one or more merchants 20 with which the user 10 will execute commercial transactions such as product purchases or acquisitions as known in the art, a transaction aggregator 30 such as a credit card issuer, and one or more rewards issuers 20.

When used herein, the term user refers to human users or customers, as well and any computing device used by the human user in order to carry out the processes and transactions of the present invention. For example, a user also refers to a user computer which may be a desktop computer, notebook computer, mobile device such as a smartphone, kiosk, interactive web-enabled television set and the like.

The term merchant refers to any person, business, vendor, service provider or other entity that transacts business with a user such as by selling an item to the user such as a product or service. Merchant also refers to any computing device (such as a merchant computer), system or the like that may be used in order to execute the various transactions described herein. For example, a merchant may be a brick and mortar establishment such as a store in a shopping mall, or a merchant may be an online merchant such as AMAZON.COM that sells items to users via the Internet as well known in the art, or a merchant may be a service provider such as an electric utility that supplies electricity to the user, etc. Communications between the user and the merchant may be carried out in any manner as known in the art, such as by a user physically visiting a merchant store, or an online transaction, or via a telephone call such as by catalog orders, etc.

A rewards issuer in accordance with this invention is a business or entity that issues rewards to a user as an incentive or reward for performing some desired act or making a purchase, such as an airline that provides frequent flier miles to users when they use that airline for a flight, or a credit card company such as AMERICAN EXPRESS which issues MEMBERSHIP REWARDS points to its customers every time they use their AMERICAN EXPRESS card to make a purchase. A rewards issuer also refers to any computing device (such as a rewards server computer), system or the like that may be used in order to execute the various transactions described herein. The term rewards includes but is not limited to reward points, loyalty points, frequent flier miles or points, rebates, coupons, etc.

A transaction aggregator in accordance with this invention is a business or entity that aggregates and settles various transactions via a merchant, for example a credit card account issuer such as CITIBANK which issues a CITIBANK VISA card as known in the art. Transaction aggregator also refers to any computing device (such as a transaction aggregator server computer), system or the like that may be used in order to execute the various transactions described herein. The transaction aggregator may in the alternative be a debit card account issuer, a smartcard account issuer, a bank or other financial institution, etc. The transaction aggregator may be a bill payment service that aggregates bills to a user from merchants into a user transaction account and pays the merchants on behalf of the user, and then invoices the user for those charges. For example, a transaction aggregator may be utilized by a user to receive and pay on his behalf his electric bill, telephone bill, credit card bill, and cable bill, and then send one user transaction account invoice/statement to the user for payment to the transaction aggregator.

The various parties described above may interact with each other through known means, typically via computer networks such as the Internet and/or various credit card networks as known in the art.

The preferred embodiment operates as follows. A user 10 has an account with the transaction aggregator 30 that enables the user to use that account to make purchases from participating merchants 20. For example, the transaction account may be a credit card account that enables the user 10 to charge purchases with merchants 20 on that account as well known in the art. The user 10 executes one or more transactions with one or more participating merchants 20 in the normal course of business, such as by making purchases of products from these merchants 20 as desired by the user. In order to make these purchases, the user provides the merchant with an identification of his transaction account, such as by presenting a physical token like a credit card, entering a credit card number in an online shopping cart form, etc. At some point during or after the purchases are made by the user 10, the merchant 20 will submit charges to the transaction aggregator 30 as known in the art. For example, credit card charges may be made via a merchant processor, using the existing credit card network as known in the art.

The transaction aggregator 30 aggregates all of the transaction account charges for each user transaction account. As described above, each of the transaction charges are received from at least one merchant for an acquisition made by a user with the at least one merchant 20. The transaction aggregator then generates an invoice/statement for the charges made by the user during a predefined period such as the past month. This process is also well known in the art.

In accordance with the present invention, the transaction aggregator 30 also provides the user 10 with an option to make at least a partial payment to the user transaction account by redeeming rewards from at least one user reward account associated with a rewards issuer 40. In order to accomplish this, the user 10 will have registered with the transaction aggregator one or more of his reward accounts held by rewards issuer 40. For example, during a registration process, the user 10 would provide the transaction aggregator 30 with an identification of a reward account (e.g. AMERICAN EXPRESS MEMBERSHIP REWARDS) as well as an account identification such as an account number and password (e.g. account #1234567889; password=abc123def). This information would then be stored in a transaction aggregator database associated with the user 10 and his account information. Depending on the reward issuer's requirements, the user 10 may be required to provide authorization to the transaction aggregator 30 to be able to execute reward redemptions on the user's behalf. This process is also well known in the art. The user 10 may register all or a subset of his reward accounts, which may be done when the transaction account is first established, or later on as may be desired.

In an exemplary embodiment, the transaction aggregator 30 may provide to the user a list of his registered reward accounts as well as the current balance of the reward points in each account. The transaction aggregator 30 may periodically refresh its reward account database by communicating with each registered rewards issuer 40 over a computer network, so that the information that is presented to the user 10 is accurate.

The user 10 will be provided with the option to make at least a partial payment to the user transaction account in conjunction with the transaction account invoice. As such, the invoice would list all of the charges made by the user 10 with the various merchants 20 during the previous billing period, and there would be a listing of the registered reward accounts as well as a listing of the reward points (as well as their redemption values) on the invoice. The user could then provide a reward redemption instruction to the transaction aggregator 30 that specifies that he would like to execute one or more reward redemption in order to pay the invoice in whole or in part.

In one embodiment, the user 10 is provided with an electronic invoice that may be reviewed by the user 10 via a web page provided by or on behalf of the transaction aggregator. This web page may then provide interactive web controls, such as text input boxes and the like, in order to allow the user to specify the desired rewards to be redeemed. The web page may be interactive and display the values of the redeemed rewards as they are entered by the user. For example, the user may see that he has 10,000 MEMBERSHIP REWARDS points available for redemption, which have a total redeemable value of $100. He may enter only 8,000 of those points and the web page would display the value of $80. The user is able to repeat this as desired with the various reward accounts and be provided with a display of the total redeemable values, as well as the balance that would be due (if any) if he elects to make those redemptions. Various types of web control elements may be used for this such as sliders, graphs, check boxes, radio buttons and the like, all of which are well known in the art. In an alternative embodiment, the user may be sent a paper invoice via the mail with the reward account values printed thereon, in which case he may write in the desired redemption amounts and submit the paper having the reward redemption instruction back to the transaction aggregator 30.

Thus, the reward redemption instruction designating the redemption of rewards from at least one user reward account is received by the transaction aggregator 30 from the user 10. The transaction aggregator 30 will then act on the redemption instruction as follows. The transaction aggregator 30 will communicate with each designated rewards issuer 40 by sending a request to the rewards issuer 40 to reduce the user's reward account by the number of points designated by the user for that account. In addition, the value of the rewards that have been redeemed is calculated and consideration in that amount is conveyed to the transaction aggregator 30 by the rewards issuer 40. This may be done in real-time, or it may be done in a batch mode such as every night, etc. The conveyance of consideration may be in any form agreed to by the parties, such as by a credit to an account that is settled periodically, or a payment may be made by check, etc. As a result of executing this reward redemption transaction, a credit is provided on the user transaction account for an amount corresponding to the value of the rewards decreased in the user reward account. This credit may offset the entire amount owed, or it may be only a partial credit, in which case the user would pay the balance in any manner known in the art (e.g. by check, EFT, etc.)

In the preferred embodiment, the credit is provided against the total amount owed for all of the transaction account charges on the user transaction account. For example, if the user executed five purchases from a merchant(s) totaling $1,500.00, and the user requested a reward redemption of $500.00, then that credit is taken off of the entire amount due and the new balance is $1,000.00. In the alternative, the credit may be provided against one of transaction account charges for the user transaction account.

As described, the transaction aggregator may a credit card issuer, in which case the user transaction account is a user credit card account, and the transaction account charges are credit card charges made to the user credit card account. In this embodiment the offering to the user an option to make at least a partial payment to the user transaction account by redeeming rewards from at least one user reward account associated with a rewards issuer is performed by providing the option on a credit card invoice transmitted to the user, the credit card invoice including a charge for the total amount of the credit card charges.

In the preferred embodiment just described, the user 10 is provided with a list of user reward accounts that may be designated by the user for the redemption of rewards. In addition, the user is provided with an indication of an amount of rewards available from each of the user reward accounts that may be designated by the user for the redemption of rewards. The reward redemption instruction then includes an amount of the rewards desired by the user to be redeemed.

In another embodiment, an automatic redemption transaction takes place. In this embodiment, an instruction is received from the user 10 designating an automatic redemption of rewards from a predetermined selection of at least one user reward account. The automatic redemption instruction may include an instruction to use all available rewards from the at least one user reward account, or it may include an instruction to use a desired percentage of available rewards from at least one user reward account. This user instruction may be provided as part of a registration process and stored in a profile database at the transaction aggregator.

In an alternative embodiment, the user 10 may elect to have his reward points redeemed and combined into a credit balance at the transaction aggregator 30, even though he may have not yet made any purchases from the merchants 20. In this embodiment, a reward exchange account would be kept at the transaction aggregator, which would hold the value of the rewards redeemed by the user. For example, the user may be able to log in to a web site operated by the transaction aggregator in order to request reward redemptions as described above, although not necessarily in conjunction with a merchant charge invoice. Instead of crediting the transaction account, the transaction aggregator may provide a user exchange account to hold the redeemed reward values, which may subsequently be applied as desired towards any future purchases. In the alternative to using a separate reward exchange account, the rewards may be redeemed directly into the user's transaction account such that a net credit is shown as a balance to the user. All of the redemption scenarios described above may also take place here, including user instructions for redeeming designated rewards and accounts, automatic redemptions, etc. As such, the user could request the transaction aggregator to periodically sweep or redeem all of his reward points from all of his accounts into an automatic credit on his transaction account. This type of reward aggregation is explained in detail for example, in U.S. Pat. No. 6,594,640, the specification of which is incorporated by reference herein.

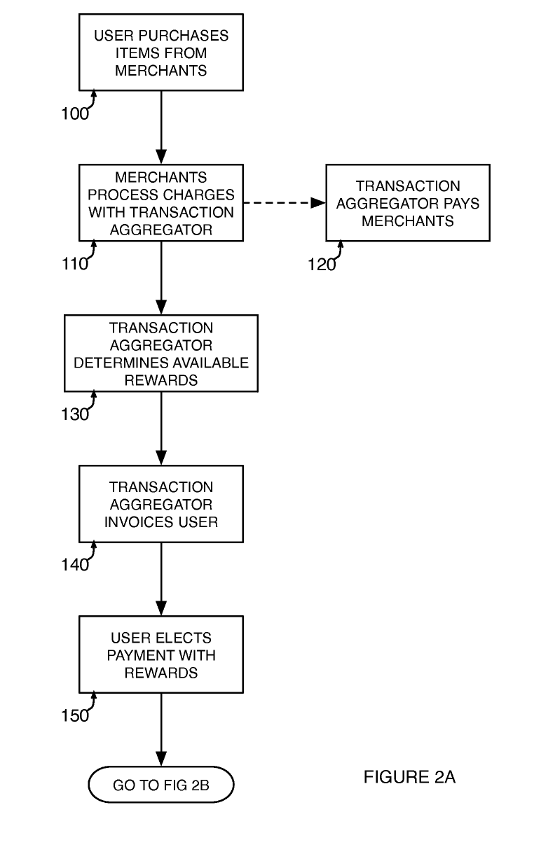

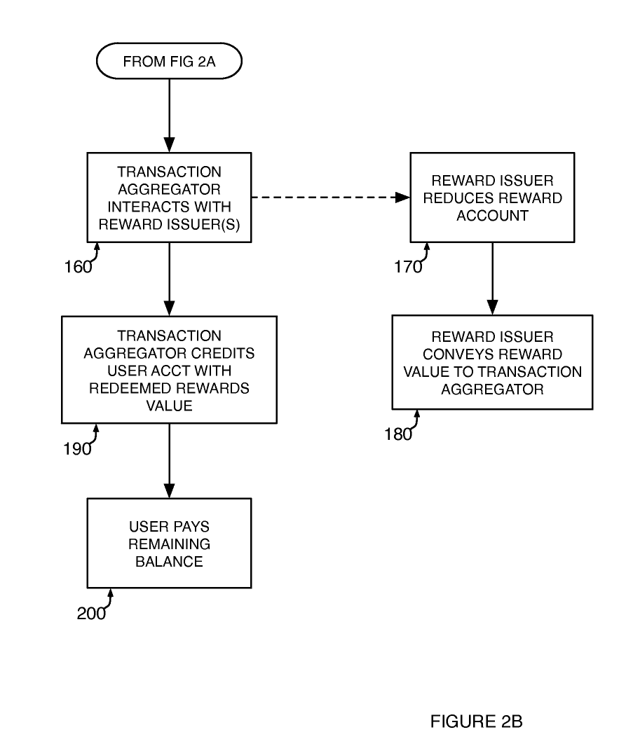

FIGS. 2A and 2B are a flowchart of the operation of preferred embodiment of the present invention. The user purchases one or more items from one or more merchants as shown at step 100. At step 110, the merchants process the charges with the transaction aggregator. At step 120, the transaction aggregator pays the merchants as known in the art. This is shown by a dotted line since it may occur ant any time. At step 130, the transaction aggregator determines the rewards that may be available for the user. At step 140, the transaction aggregator sends an invoice the user that includes the current charges from the merchants as well as an indication of the rewards that may be redeemed towards payment of the invoice. At step 150, the user elects to make a payment towards the invoice by redeeming rewards. At step 160, the transaction aggregator interacts with the designated reward issuers in order to make the desired redemptions. At step 170, the reward issuer is requested by the transaction aggregator to reduce the rewards in the user's reward account by the designated amount. At step 180, the reward issuer conveys consideration to the transaction aggregator having a value equivalent to the redeemed rewards. These steps 170, 180 are shown by a dotted line since they may occur ant any time. At step 190, the transaction aggregator credits the user account with the value of the redeemed rewards, and at step 200 the user pays the balance that may remain on the account.

What is claimed is:

1. A computer-implemented method comprising:
a transaction aggregator server computer offering to a user an option to make at least a partial payment to a user transaction account by redeeming rewards from at least one user reward account associated with a rewards issuer;
receiving a reward redemption instruction from the user, the reward redemption instruction designating the redemption of rewards from at least one user reward account;
causing the at least one user reward account designated by the user to redeem the rewards by decreasing the rewards in the user reward account and conveying corresponding consideration to the transaction aggregator; and
providing a credit on the user transaction account for an amount corresponding to the value of the rewards decreased in the user reward account.

2. The method of claim 1 further comprising:
the transaction aggregator server computer aggregating a plurality of transaction account charges for the user transaction account, each of said transaction charges received from at least one merchant for an acquisition made by the user with the at least merchant.

3. The method of claim 2 wherein the acquisition made by the user with the at least one merchant comprises a product.

4. The method of claim 2 wherein the acquisition made by the user with the at least one merchant comprises a service.

5. The method of claim 2 wherein the credit is provided against a total amount owed for the plurality of transaction account charges on the user transaction account.

6. The method of claim 2 wherein the credit is provided against one of the plurality of transaction account charges for the user transaction account.

7. The method of claim 2 wherein the transaction aggregator is a credit card issuer, the user transaction account is a user credit card account, and the transaction account charges are credit card charges made to the user credit card account.

8. The method of claim 2 wherein the transaction aggregator is a debit card issuer, the user transaction account is a user debit card account, and the transaction account charges are debit card charges made to the user debit card account.

9. The method of claim 2 wherein the transaction aggregator is a smart card issuer.

10. The method of claim 2 wherein the transaction aggregator is a bill payment service and the transaction account charges are bills that are paid by the transaction aggregator on behalf of the user.

11. The method of claim 1 wherein offering to the user an option to make at least a partial payment to the user transaction account by redeeming rewards from at least one user reward account associated with a rewards issuer comprises providing the option on a transaction account statement transmitted to the user.

12. The method of claim 11 wherein the transaction account statement is a paper statement transmitted to the user via mail.

13. The method of claim 11 wherein the transaction account statement is an electronic statement made available to the user via a web site.

14. The method of claim 1 further comprising:
providing to the user a list of user reward accounts that may be designated by the user for the redemption of rewards.

15. The method of claim 14 further comprising:
providing to the user an indication of an amount of rewards available from each of the user reward accounts that may be designated by the user for the redemption of rewards.

16. The method of claim 15 wherein the reward redemption instruction comprises an amount of rewards desired by the user to be redeemed.

17. The method of claim 1 wherein the receiving of a reward redemption instruction from the user, the reward redemption instruction designating the redemption of rewards from at least one user reward account, comprises:
receiving an automatic redemption instruction from the user designating an automatic redemption of rewards from a predetermined selection of at least one user reward account.

18. The method of claim 17 wherein the automatic redemption instruction comprises an instruction to use a desired percentage of rewards from the at least one user reward account.

19. The method of claim 17 wherein the automatic redemption instruction comprises an instruction to use a predetermined number of rewards from the at least one user reward account.

20. A transaction aggregator server computer programmed to:
offer to a user an option to make at least a partial payment to a user transaction account by redeeming rewards from at least one user reward account associated with a rewards issuer;
receive a reward redemption instruction from the user, the reward redemption instruction designating the redemption of rewards from at least one user reward account;
cause the at least one user reward account designated by the user to redeem the rewards by decreasing the rewards in the user reward account and conveying corresponding consideration to the transaction aggregator; and
provide a credit on the user transaction account for an amount corresponding to the value of the rewards decreased in the user reward account.

21. The transaction aggregator server computer of claim 20 further programmed to:
aggregate a plurality of transaction account charges for the user transaction account, each of said transaction charges received from at least one merchant for an acquisition made by the user with the at least one merchant.

22. The transaction aggregator server computer of claim 21 wherein the acquisition made by the user with the at least one merchant comprises a product.

23. The transaction aggregator server computer of claim 21 wherein the acquisition made by the user with the at least one merchant comprises a service.

24. The transaction aggregator server computer of claim 21 wherein the credit is provided against a total amount owed for the plurality of transaction account charges on the user transaction account.

25. The transaction aggregator server computer of claim 21 wherein the credit is provided against one of the plurality of transaction account charges for the user transaction account.

26. The transaction aggregator server computer of claim 21 wherein the transaction aggregator is a credit card issuer, the user transaction account is a user credit card account, and the transaction account charges are credit card charges made to the user credit card account.

27. The transaction aggregator server computer of claim 21 wherein the transaction aggregator is a debit card issuer, the user transaction account is a user debit card account, and the transaction account charges are debit card charges made to the user debit card account.

28. The transaction aggregator server computer of claim 21 wherein the transaction aggregator is a smart card issuer.

29. The transaction aggregator server computer of claim 21 wherein the transaction aggregator is a bill payment service and the transaction account charges are bills that are paid by the transaction aggregator on behalf of the user.

30. The transaction aggregator server computer of claim 20 programmed to offer to the user an option to make at least a partial payment to the user transaction account by redeeming rewards from at least one user reward account associated with a rewards issuer by providing the option on a transaction account statement transmitted to the user.

31. The method of claim 30 wherein the transaction account statement is a paper statement transmitted to the user via mail.

32. The method of claim 30 wherein the transaction account statement is an electronic statement made available to the user via a web site.

33. The transaction aggregator server computer of claim 20 further programmed to:
provide to the user a list of user reward accounts that may be designated by the user for the redemption of rewards.

34. The transaction aggregator server computer of claim 33 further programmed to:
provide to the user an indication of an amount of rewards available from each of the user reward accounts that may be designated by the user for the redemption of rewards.

35. The transaction aggregator server computer of claim 34 wherein the reward redemption instruction comprises an amount of rewards desired by the user to be redeemed.

36. The transaction aggregator server computer of claim 20 programmed to receive a reward redemption instruction from the user, the reward redemption instruction designating the redemption of rewards from at least one user reward account, by:
receiving an automatic redemption instruction from the user designating an automatic redemption of rewards from a predetermined selection of at least one user reward account.

37. The transaction aggregator server computer of claim 36 wherein the automatic redemption instruction comprises an instruction to use all available rewards from the at least one user reward account.

38. The transaction aggregator server computer of claim 36 wherein the automatic redemption instruction comprises an instruction to use a desired percentage of available rewards from the at least one user reward account.
